(19) United States
(12) Patent Application Publication
(10) Pub. No.: US 2009/0258286 A1
(43) Pub. Date: Oct. 15, 2009

(54) Modular battery pack and computer and familly of computers having a modular battery pack

(75) Inventor: Phu Ho, Mission Viejo, CA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 12/082,379

(22) Filed: Apr. 10, 2008

(51) Int. Cl. H01M 2/10

(52) U.S. Cl. 429/100

(57) ABSTRACT

A stackable modular battery pack system is disclosed that includes at least two modular battery packs, including first and second battery packs. Each of the modular battery packs comprises a case in which a battery is disposed, first electrical contacts electrically connected to the battery and disposed on an exterior of the case, and second electrical contacts electrically connected to the battery, with the second electrical contacts being disposed on the exterior of the case. The case of the first battery pack is configured to releasably engage the case of the second battery case. The first electrical contacts are located on the first battery case and the second electrical contacts are located on the second battery case so that the first electrical contacts contact the second electrical contacts where the case of the first battery case and the case of the second electrical contacts are engaged.

### BACKGROUND AND SUMMARY

The present invention relates to a battery pack and, more particularly, to a modular battery pack adapted to be combined with other battery packs, particularly for use in connection with computers, particularly laptop or notebook type computers.

Many modern, battery powered computers, such as notebook or laptop computers, have different power requirements and use custom battery packs usable only with one computer model. Furthermore, it is often desired to offer batteries of different charge capacities for the same computer. For example, users who travel may require use of the computer for longer time periods between battery recharging events and may desire a battery of enhanced capacity despite the higher battery cost, while more typical users may only need a battery of a reduced capacity and do not want to pay the higher cost of a battery having a higher capacity. It is therefore not uncommon to offer different batteries of different capacities for the same computer which are interchangeable on the computer. Further, higher capacity batteries typically weigh more and than lower capacity batteries, and thus add weight to portable computers, and while some users may be willing to tolerate the greater weight to obtain the longer battery charge life, other users may not. As a result, substantial inventories of different battery configurations must be maintained to manufacture different computer models or to permit a repair facility to replace a computer's battery. It is desirable to avoid the need for substantial inventories and to simplify the manufacture and repair of computers, while still providing consumers with a range of battery capacities to meet their needs and budgets.

In accordance with an aspect of the present invention, a stackable modular battery pack system comprises at least two modular battery packs including a first battery pack and a second battery pack. Each of the modular battery packs may comprise a case in which a battery is disposed, first electrical contacts electrically connected to the battery and disposed on an exterior of the case and second electrical contacts electrically connected to the battery. The second electrical contacts may be disposed on the exterior of the case. The case of the first battery pack may be configured to releasably engage the case of the second battery case. The first electrical contacts may be located on the first battery case and the second electrical contacts may be located on the second battery case so that the first electrical contacts contact the second electrical contacts where the case of the first battery case and the case of the second electrical contacts are engaged.

In accordance with another aspect of the present invention, a stackable modular battery pack is disclosed, and includes a case in which a battery is disposed, first electrical contacts electrically connected to the battery and disposed on an exterior of the case, and second electrical contacts electrically connected to the battery, with the second electrical contacts being disposed on the exterior of the case. The first electrical contacts may be located on a first side of the case and the second electrical contacts may be located on a second side of the case, and the first and second sides may be located on substantially opposite locations on the case. The case may include a male connecting structure and a female connecting structure. The first electrical contacts may be associated with a first one of the male and female connecting structures and the second electrical contacts may be associated with a second one of the male and female connecting structures.

### BRIEF DESCRIPTION OF THE DRAWINGS

The features and advantages of the present invention are well understood by reading the following detailed description in conjunction with the drawings in which like numerals indicate similar elements and in which:

FIG. 1A is a schematic top, rear perspective views of a battery module according to an aspect of the present disclosure showing a door in a closed position and a male lock member in an extended position;

FIG. 1B is a schematic top, rear perspective views of a battery module according to an aspect of the present disclosure showing a door in an open position and a male lock member in a retracted position;

FIG. 1C is a schematic top, front perspective view of the battery module of FIGS. 1A and 1B;

FIG. 2A is a schematic partial cross-sectional view of battery modules according to an aspect of the present invention in a separated condition;

FIG. 2B is a schematic partial cross-sectional view of battery modules according to an aspect of the present invention in a joined condition;

FIG. 3 is a schematic partial cross-sectional view of a battery module according to another aspect of the present disclosure;

FIG. 4 is a schematic perspective view of a portion of a battery module according to another aspect of the present disclosure; and

FIG. 5A is a schematic partial cross-sectional side view of a computer with a pair of modular batteries according to an aspect of the present disclosure; and

FIG. 5B is a schematic partial cross-sectional side view of the computer of a family of computers with three modular batteries according to the present disclosure.

### DETAILED DESCRIPTION

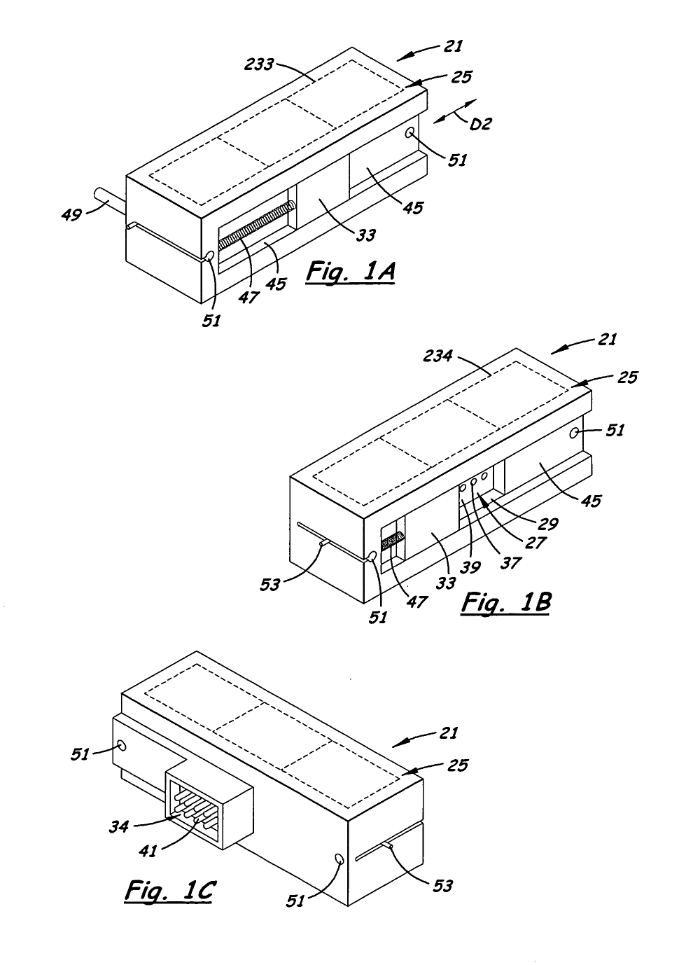

A modular battery pack 21 according to an aspect of the present invention is shown in FIGS. 1A-1C. The modular battery pack 21 comprises a battery and a case 25 in which the battery is disposed. The battery can be any suitable type of battery, however, it is presently believed that a three cell battery 233 (shown in phantom in FIG. 1A) or four cell battery 234 (shown in phantom in FIG. 1B) will be of particular use in applications such as powering laptop or notebook computers.

As seen in FIG. 1B, first electrical contacts 27 may be provided that are electrically connected to the battery 233 of the battery pack 21, and the contacts 27 may be disposed in a recess 29 in the case 25 of the pack 21. As seen in FIG. 1C, second electrical contacts 31 may be provided that are electrically connected to the battery 233 in any suitable fashion. Additional contacts or pins may be included on the case 25 that are not in communication with the battery, and may be provided for purposes other than communicating power. These additional contacts may be employed, as an example, for communicating control information between battery packs, and between a battery pack and the device being powered by the battery pack.

A door 33 may be provided on the case 25, and may be arranged to cover the first contacts 27. The door 33 may be slidable between two or more positions, such as an open position shown in FIG. 1B to expose the first contacts 27 and a closed position shown in FIG. 1A to cover the first contacts. The case 25 have connecting structures formed thereon for removably connecting to suitably configured connecting structures on another case. In one embodiment, the connecting structure may include a male member 35 extending from the case 25 and the connecting structure may also include the recess 29. The male member 35 may be configured to removably insert into the recess 29.The second contacts 31 may be disposed in the male member 35.

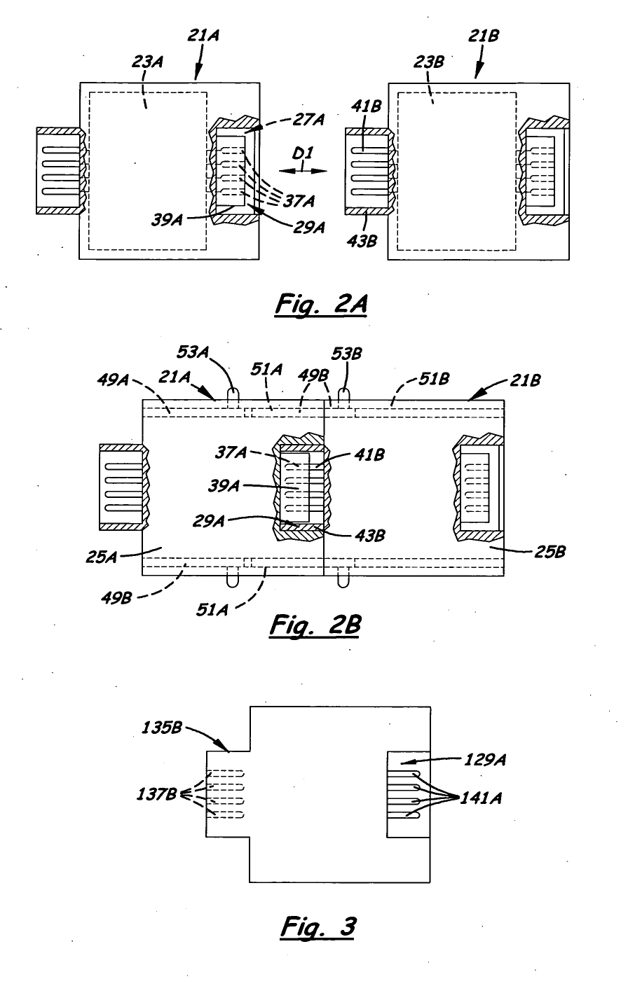

As seen in FIG. 2A, when the door 33 on a first modular battery pack 21a is opened, the first contacts 27a connected to the battery 23a may be exposed. The male member 35b on a similarly configured second modular battery pack 21b may be adapted to be moved in a first direction D1 into the recess 29a on the first modular battery pack 21a so that the first contacts 27a on the first modular battery pack and the second contacts 31b on the second modular battery pack mate as seen in FIG. 2B. The second contacts 31b are connected to the battery 23b (shown in phantom). In the embodiment shown in FIGS. 2A and 2B, the first contacts 27a are female contacts comprising openings 37a in a platform 39a in the recess 29a, and the second contacts 31b are male contacts comprising pins 41b surrounded by a rigid wall 43b defining the male member 35b. The wall 43b may be adapted to be received in the recess 29a and surround the platform 39a. Those skilled in the art will recognize that the configuration of the first 27a and second 31b contacts may be reversed. For example, as seen in FIG. 3, instead of the configuration shown in FIGS. 2A-2B, pins 141a can be disposed in a recess 129a and openings 137b for the pins can be disposed in a male member 135b.

As seen in FIG. 1A and 1B, the door 33 may be adapted to slide in a slot 45 in the case between a first closed position (FIG. 1A) in which the door covers the first contacts and a second open position (FIG. 1B) in which the first contacts 27 are exposed. A resilient member 47 such a spring, compressible foam, or the like, may be provided for urging or biasing the door 33 toward the first closed position so that the recess 29 and the structures, such as openings 37 for the first contacts 27 on a platform 39, will ordinarily be covered by the door when not exposed for purposes of connecting the male member 35 and the structures, such as pins 41 for the second contacts 31, that connect to the structures in the recess. The slot 45 of a first modular battery pack may be adapted to receive the male member 35 of a second modular battery pack in a second direction D2 (FIG. 1A) substantially perpendicular to the first direction to move the door to the second position.

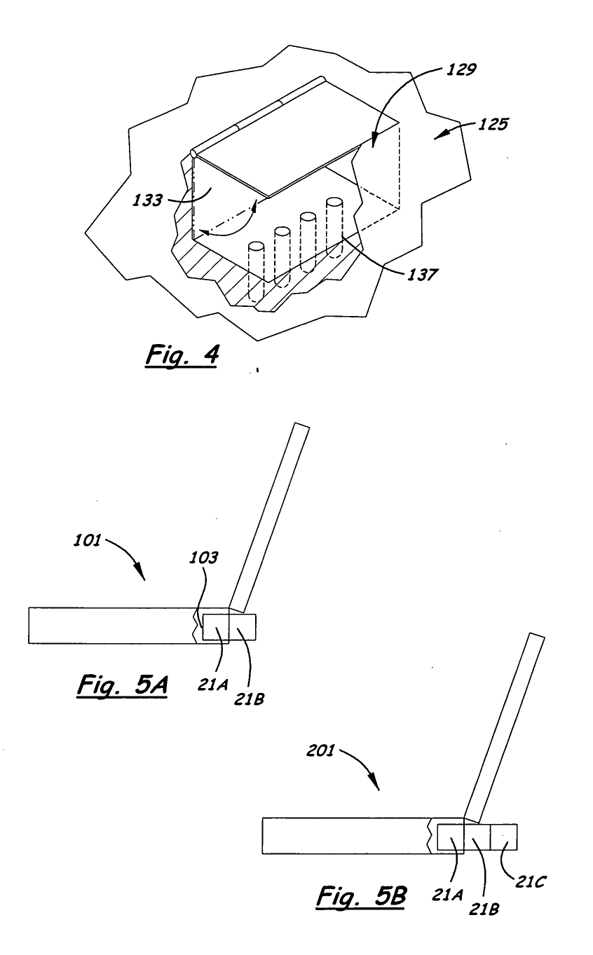

As seen in FIG. 4, the door 133 may be a hinged door that is pivotable about a hinge 135 between a first closed position in which the door covers the first contacts and a second open position in which the first contacts are exposed. The hinged door 133 can pivot into the recess 129 in the case 125 upon being contacted by the male member of another modular battery pack or can be pivoted out of the recess and out of the way to permit the male member to be received in the recess. In an embodiment with a hinged door 133 that pivots into the recess 129, one suitable form of contacts 137 may include sliding contacts positioned on or against a wall located opposite of the wall of the recess proximate which the door is attached and toward which the door moves.

As seen in FIG. 2B, a lock may be provided on the case for securing the first modular battery pack 21a to the second modular battery pack 21b to help support or transfer the weight of the second modular battery pack to the first modular battery pack, instead of having the entire weight of the second pack being borne by the male member/recess connection and any pin/recess connections. The lock can be in any suitable form. FIG. 2B shows one illustrative example, in which a case 25a and a case 25b include a male lock member 49a and 49b disposed in a lock slot 51a and 51b in the case. The lock can be locked when the male lock member 49b in the lock slot 51b in the case 25b of the second modular battery 21b is slid in the lock slot 51b and received in the lock slot 51a of the first modular battery pack 21a, or vice versa. A projection 53a and 53b can be provided on each of the lock members 49a and 49b to assist in finger movement of the lock members relative to the lock slots 51b. As seen in FIGS. 1A-1C, the lock slots 51 can extend to an outer surface of the case 25 and the projection 53 from the lock members 49 can extend through the lock slots. It should be recognized that corresponding lock slots may be formed on the housing of a laptop or portable computer to removably secure the battery pack or packs to the computer.

As seen, for example, in FIGS. 1B-1C, the second contacts 31 may ordinarily be disposed on the case at a location that is remote from a location of the first contacts 27 on the case. The second contacts 31 may be of a type that is adapted to mate with the first contacts. Typically, the recess 29 for the first contacts 27 is disposed on a first side 55 of the case 25 and the male member 35 for the second contacts 31 is disposed on a second side 57 of the case, and the first and second sides 55, 57 typically face in substantially opposite directions on the case to facilitate the connection of a plurality of battery modules in a linear arrangement. The positioning of the first contacts and second contacts on opposite sides of the case 25 permits the stacking of additional modular battery packs onto a battery pack that is mounted on a laptop or portable computer in a manner that merely extends or enlarges the overall dimension of the computer assembly in one direction (see FIGS. 5A and 5B).

FIGS. 5A and 5B show computers 101 and 201 that may be members of a family of battery powered computers. The first computer 101 has first battery power requirements that can be met using, for example, two connected modular battery packs 21a and 21b, and the second computer 201 has second battery power requirements different from the first battery power requirements that can be met using, for example, three connected modular battery packs 21a, 21b, and 21c. The battery power requirements may include virtually any characteristic of power provided by a battery. The requirements may include, for example, current requirements, voltage requirements, and charge capacity (operation time) requirements. Significantly, the addition of a second battery pack to a first battery pack mounted on a device such as a computer may provide twice the charge capacity of the first battery pack alone. The addition of further battery packs may further increase the charge capacity of the overall battery pack assembly associated with the device. Other computers can have still other power requirements that can be met by other numbers of connected modular battery packs. It will be understood that all computers of the family of computers may be designed so that their power requirements can be met by some combination of one or more of the modular battery packs. The modular battery packs will ordinarily be connected in parallel with other substantially identically-equipped (or identically-equipped) modular battery packs to provide the requisite power. The first computer 101 and the second computer 201 may be notebook or laptop computers, although they can be desk top computers or other types of devices that can be broadly classified as computers.

As seen in FIG. 5A, the first computer 101 defines a first computer footprint and includes an opening 103 or cavity configured to receive the first modular battery pack 21a inside the first computer footprint. The at least one other modular battery pack 21b may be disposed outside the first computer footprint. Other computers can define computer footprints in which more than one modular battery pack is disposed inside the computer footprint, or in which no modular battery packs are disposed inside the computer footprint.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this invention has been illustrated and described in accordance with a preferred embodiment, it is recognized that variations and changes may be made therein without departing from the invention as set forth in the claims.

What is claimed is:

1. A stackable modular battery pack system, comprising:
at least two modular battery packs including a first battery pack and a second battery pack, each of the modular battery packs comprising:
a case in which a battery is disposed;
first electrical contacts electrically connected to the battery and disposed on an exterior of the case;
second electrical contacts electrically connected to the battery, the second electrical contacts being disposed on the exterior of the case;
wherein the case of the first battery pack is configured to releasably engage the case of the second battery case; and
wherein the first electrical contacts are located on the first battery case and the second electrical contacts are located on the second battery case so that the first electrical contacts contact the second electrical contacts where the case of the first battery case and the case of the second electrical contacts are engaged.

2. The system of claim 1 wherein the case of the first battery pack and the case of the second battery pack are configured substantially identical to each other.

3. The system of claim 1 wherein the second electrical contacts are positioned at a location on the case remote from the first electrical contacts on the case.

4. The system of claim 1 wherein the first electrical contacts are located on a first side of the case and the second electrical contacts are located on a second side of the case, the first and second sides being located on substantially opposite locations on the case.

5. The system of claim 1 wherein the case of the first battery pack is configured to removably interlock with the case of the second battery pack.

6. The system of claim 5 wherein the case includes a male member extending outwardly from the exterior of the case and the case includes a recess extending into the exterior of the case.

7. The system of claim 6 wherein the first electrical contacts are disposed in the recess and the second electrical contacts are disposed on the male member.

8. The system of claim 6 wherein the case includes a door configured to selectively cover a portion of the recess.

9. The system of claim 8 wherein the door is configured to slide between a closed position in which contacts in the recess are covered and an open position in which the contact in the recess are exposed.

10. The system of claim 1 wherein the door is configured to pivot between a protecting position in which the male member is capable of being inserted into the recess;

11. The system of claim 1 wherein the case includes a lock assembly configured to releasably lock the cases of the battery packs together with the first electrical contacts of a first one of the battery packs to the second electrical contacts of a second one of the battery packs.

12. The system of claim 11 wherein the lock assembly includes at least one lock member movably mounted on the case of the first one of the battery packs and a slot on the case of the second one of the battery packs, the at least one lock member being slidable into the slot when the case of the first one of the battery packs is engaged with the case of the second one of the battery packs.

13. The system of claim 1 comprising at least three of the modular battery packs including the first battery pack, the second battery pack, and a third battery back; and
wherein each of the modular battery packs are engagable in a linear configuration with the second battery pack physically engaged with and in electrical communication with the first battery pack, and the third battery pack physically engaged with and in electrical communication with the second battery pack:

14. The system of claim 1 wherein engagement of the first battery pack and the second battery pack is configured to provide a multiple of an electrical characteristic of the first battery pack alone.

15. A stackable modular battery pack, comprising:
a case in which a battery is disposed;
first electrical contacts electrically connected to the battery and disposed on an exterior of the case;
second electrical contacts electrically connected to the battery, the second electrical contacts being disposed on the exterior of the case;
wherein the first electrical contacts are located on a first side of the case and the second electrical contacts are located on a second side of the case, the first and second sides being located on substantially opposite locations on the case; and
wherein the case includes a male connecting structure and a female connecting structure, the first electrical contacts being associated with a first one of the male and female connecting structures and the second electrical contacts being associated with a second one of the male and female connecting structures.

16. The battery pack of claim 15 wherein the male connecting structure comprises a male member extending outwardly from the exterior of the case and the female connecting structure comprises a recess extending into the exterior of the case.

17. The battery pack of claim 16 wherein the first electrical contacts are disposed in the recess and the second electrical contacts are disposed on the male member.

18. The battery pack of claim 16 wherein the case includes a door configured to selectively cover a portion of the recess.

19. The battery pack of claim 15 wherein the case includes a lock assembly configured to releasably lock the cases of battery packs together.

20. The battery pack of claim 19 wherein the lock assembly includes at least one lock member movably mounted on the case and a slot formed on the case.
